(19) United States
(12) Patent Application Publication
(10) Pub. No.: US 2013/0301562 A1
(43) Pub. Date: Nov. 14, 2013

(54) Methods for Resource Multiplexing of Distributed and Localized transmission in Enhanced Physical Downlink Control Channel

(71) Applicant: MEDIATEK, INC., Hsin-Chu (TW)

(72) Inventors: Pei-Kai Liao, Nantou County (TW); Xiangyang Zhuang, Lake Zurich, IL (US)

(73) Assignee: MEDIATEK, INC., Hsin-Chu (TW)

(21) Appl. No.: 13/889,554

(22) Filed: May 8, 2013

Related U.S. Application Data
(60) Provisional application No. 61/644,954, filed on May 9, 2012.

(51) Int. Cl. H04W 72/04

(52) U.S. Cl. CPC H04W 72/042
USPC 370/329

(57) ABSTRACT

A method to multiplexing physical radio resources for both distributed and localized transmission of enhanced Physical Downlink Control Channel (ePDCCH) in a set of physical resource blocks (PRBs) is provided. A UE receives higher-layer information to determine a set of radio resources. The UE decodes a first set of candidate enhanced physical downlink control channel (ePDCCHs) within the set of received radio resources, wherein radio resources corresponding to each of the first set of ePDCCHs are defined by a first mapping rule (e.g., distributed-type ePDCCH). The UE decodes a second set of candidate ePDCCHs within the same set of received radio resources, wherein radio resources corresponding to each of the second set of candidate ePDCCHs are defined by a second mapping rule (e.g., localized-type ePDCCH). By multiplexing radio resources for distributed and localized ePDCCH transmission within the same set of PRBs, radio resource utilization is enhanced.

### CROSS REFERENCE TO RELATED APPLICATIONS

This application claims priority under 35 U.S.C. §119 from U.S. Provisional Application No. 61/644,954, entitled “Methods for Resource Multiplexing of Distributed and Localized Transmission in Enhanced Physical Downlink Control Channel,” filed on May 9, 2012, the subject matter of which is incorporated herein by reference.

### TECHNICAL FIELD

The disclosed embodiments relate generally to physical downlink control channel (PDCCH), and, more particularly, to resource multiplexing of distributed and localized transmission in enhanced ePDCCH in OFDM/OFDMA systems.

### BACKGROUND

In 3GPP Long-Term Evolution (LTE) networks, an evolved universal terrestrial radio access network (E-UTRAN) includes a plurality of base stations, e.g., evolved Node-Bs (eNBs) communicating with a plurality of mobile stations referred as user equipment (UEs). Orthogonal Frequency Division Multiple Access (OFDMA) has been selected for LTE downlink (DL) radio access scheme due to its robustness to multipath fading, higher spectral efficiency, and bandwidth scalability. Multiple access in the downlink is achieved by assigning different sub-bands (i.e., groups of subcarriers, denoted as resource blocks (RBs)) of the system bandwidth to individual users based on their existing channel condition. In LTE networks, Physical Downlink Control Channel (PDCCH) is used for dynamic downlink scheduling. In the current LTE specification, PDCCH can be configured to occupy the first one, two, or three OFDM symbols in a subframe.

One promising technology for LTE is the use of Multiple Input Multiple Output (MIMO) antennas that can further improve the spectral efficiency gain by using spatial division multiplexing. Multiple antennas allow for an additional degree of freedom to the channel scheduler. Multi-user MIMO (MU-MIMO) is considered in LTE Rel-10. As compared to Single-user MIMO (SU-MIMO), MU-MIMO offers greater spatial-domain flexibility by allowing different users to be scheduled on different spatial streams over the same RB. By scheduling the same time-frequency resource to multiple UEs, more UEs will be scheduled in the same subframe to take advantage of spatial multiplexing. To enable MU-MIMO, individual control signaling must be indicated to each UE via PDCCH. As a result, more PDCCH transmissions are expected, as the number of scheduled UEs per subframe will increase. However, the maximum 3-symbol PDCCH region may not be enough to accommodate the increased number of UEs in LTE. Due to limited control channel capacity, the MIMO performance degrades because of non-optimized MU-MIMO scheduling.

In LTE Rel-11, various deployment scenarios for cooperative multi-point (CoMP) transmission/reception are introduced. Among the different CoMP scenarios, CoMP scenario 4 refers to Single Cell ID CoMP in heterogeneous network with low-power remote radio heads (RRH). In CoMP scenario 4, low-power RRHs are deployed within the macrocell coverage provided by macro-eNB. The RRHs have the same cell IDs as the macrocell. In such single cell ID CoMP operation, PDCCH must be transmitted from all transmission points and then soft combined without cell-splitting gain. Because the physical signal generation of PDCCH is linked to cell ID, UEs served by different points can only share the same physical resource for PDCCH if the same cell ID is shared among the different points. This creates a control channel capacity problem similar to the MU-MIMO situation illustrated above.

To address the control channel capacity problem, an UE-specific downlink scheduler for MU-MIMO/CoMP has been proposed. In LTE, it extends the PDCCH design to a new X-PDCCH, which is in the legacy Physical Downlink Shared Channel (PDSCH). How to signal UEs about the scheduling information of X-PDCCH, however, is unclear. For example, if the signaling is provided by PDCCH for each UE, then the same control channel capacity problem occurs. On the other hand, if the signaling is configured by higher-layer, then control overhead of X-PDCCH cannot be adjusted dynamically.

In 3GPP RAN1#65, the issue of downlink control capacity was first discussed for CoMP scenario 4, where both macrocell base station and remote radio heads (RRH) inside the macrocell coverage share the same physical cell ID. It has been proposed that a new physical control channel inside the region of PDSCH to be used for additional control capacity. In 3GPP RAN1#66, it was agreed as a working assumption to have a new physical control channel inside the region of legacy PDSCH. The main benefits to have this new physical control channel are for the better support of HetNet, CoMP, and MU-MIMO. In 3GPP RAN#54, a new working item (WI) for enhanced downlink control channel is agreed as Release 11 new feature. In 3GPP RAN1#68, it was agreed that an enhanced physical downlink control channel (ePDCCH) spans both first and second slots in the region of legacy PDSCH.

To exploit both diversity and beamforming/scheduling gain in ePDCCH, both distributed and localized transmission schemes are supported. However, supporting both distributed and localized transmission in different physical resources may result in excessive control overhead if both frequency diversity and beamforming gain have to be guaranteed. In order to minimize the control overhead, resource utilization gain needs to be enhanced and multiplexing physical resource for both distributed and localized transmission of ePDCCH in one physical resource block (PRB) may be necessary. How to multiplexing data resource elements (REs) and antenna ports in one PRB or PRB pairs for both distributed and localized transmission of ePDCCH remains unclear.

### SUMMARY

A method to multiplexing physical radio resources for both distributed and localized transmission of enhanced Physical Downlink Control Channel (ePDCCH) in a set of physical resource blocks (PRBs) is provided. A UE receives higher-layer information (e.g., via radio resource control (RRC) signaling) to determine a set of radio resources (e.g., PRB or PRB pairs). The UE decodes a first set of candidate enhanced physical downlink control channel (ePDCCHs) within the set of radio resources, wherein radio resources corresponding to each of the first set of ePDCCHs are defined by a first mapping rule. The UE decodes a second set of candidate ePDCCHs within the same set of radio resources, wherein radio resources corresponding to each of the second set of candidate ePDCCHs are defined by a second mapping rule.

In one embodiment, the first mapping rule is for distributed-type ePDCCH, where the radio resources employed by a distributed-type ePDCCH are distributed in the entire operation bandwidth (scattered over non-contiguous set of PRBs). The second mapping rule is for localized-type ePDCCH, where the radio resources employed by a localized-type ePDCCH are within one or a contiguous set of PRBs. By multiplexing radio resources for distributed and localized ePDCCH transmission within the same set of PRBs, radio resource utilization is enhanced.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates a mobile communication network with radio resource multiplexing for ePDCCH transmission in accordance with one novel aspect.

FIG. 2 is a simplified block diagram of a base station and a user equipment in accordance with embodiments of the present invention.

FIG. 3 illustrates one example of radio resource configuration for distributed ePDCCH transmission.

FIG. 4 illustrates a first embodiment of radio resource multiplexing for both distributed and localized ePDCCH transmission.

FIG. 5 illustrates a second embodiment of radio resource multiplexing for both distributed and localized ePDCCH transmission.

FIG. 6 is a flow chart of a method of radio resource multiplexing for ePDCCH transmission from UE perspective in accordance with one novel aspect.

FIG. 7 is a flow chart of a method of radio resource multiplexing for ePDCCH transmission from eNodeB perspective in accordance with one novel aspect.

### DETAILED DESCRIPTION

Reference will now be made in detail to some embodiments of the invention, examples of which are illustrated in the accompanying drawings.

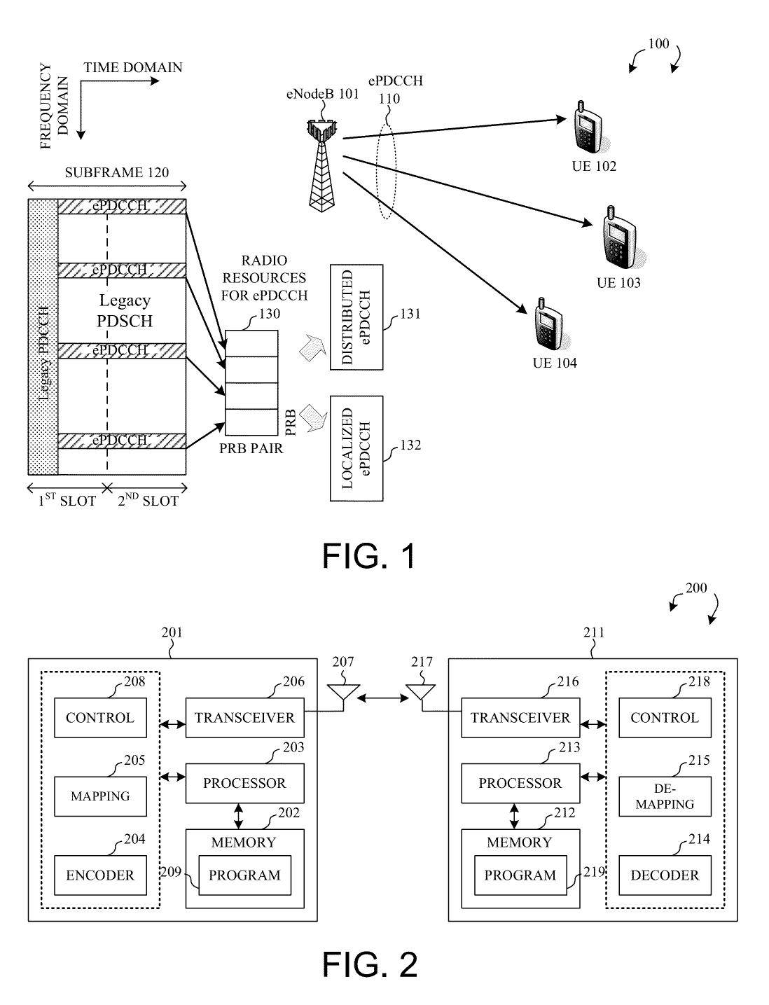

FIG. 1 illustrates a mobile communication network 100 with radio resource multiplexing for both distributed and localized ePDCCH transmission within one PRB in accordance with one novel aspect. Mobile communication network 100 is an OFDM/OFDMA system comprising a base station eNodeB 101 and a plurality of user equipment (UE) 102, UE 103, and UE 104. When there is a downlink packet to be sent from eNodeB to UE, each UE gets a downlink assignment, e.g., a set of radio resources in a physical downlink shared channel (PDSCH). When a UE needs to send a packet to eNodeB in the uplink, the UE gets a grant from the eNodeB that assigns a physical downlink uplink shared channel (PUSCH) consisting of a set of uplink radio resources. The UE gets the downlink or uplink scheduling information from a physical downlink control channel (PDCCH) that is targeted specifically to that UE. In addition, some of broadcast control information, such as system information blocks, random access response and paging information is also scheduled by PDCCH and is sent in PDSCH to all UEs in a cell. The downlink or uplink scheduling information, carried by PDCCH, is referred to as downlink control information (DCI).

In 3GPP LTE system based on OFDMA downlink, the radio resource is partitioned into subframes, each of which is comprised of two slots and each slot has seven OFDMA symbols along time domain. Each OFDMA symbol further consists of a number of OFDMA subcarriers along frequency domain depending on the system bandwidth. The basic unit of the resource grid is called Resource Element (RE), which spans an OFDMA subcarrier over one OFDMA symbol. A physical resource block (PRB) occupies one slot and twelve subcarriers, while a PRB pair occupies two consecutive slots. In an evolved LTE system, an enhanced PDCCH (ePDCCH) spans both first and second slots in the region of legacy PDSCH.

In the example of FIG. 1, ePDCCH 110 is used for eNodeB 101 to send DCI to the UEs. In order to decode ePDCCH targeted specifically to a UE, the UE needs to find out where its ePDCCH is. In the so-called “blindly” decoding process, the UE must try a number of candidate ePDCCHs before knowing which ePDCCH is targeted for itself. The set of candidate ePDCCHs that a UE needs to try one by one is referred to as UE-specific search space (UESS). In addition to UE-specific search space, each UE must also search for a number of candidate ePDCCHs, which schedule broadcast control information and is referred to as common search space (CSS).

In an evolved LTE system, the blind decoding of ePDCCH requires a UE to use UE-specific reference signal, also known as Dedicated RS (DRS), rather cell-specific reference signal (CRS). The benefit of using DRS is that eNodeB can flexibly allocate transmission power and adjust transmission mode for the reference signal together with data tones to the target UE, rather than being confined to fixed transmission power and transmission mode for the reference signal, which may be different from data tones to all UEs. An ePDCCH may be of distributed type, where the radio resources employed by a distributed-type ePDCCH are distributed in the entire operation bandwidth. An ePDCCH may be of localized type, where the radio resources employed by a localized-type ePDCCH are within one or a contiguous set of PRBs. Typically, CSS may use ePDCCHs of distributed type for maximal frequency diversity, while UESS may use ePDCCHs of localized type for beamforming gain. Supporting both distributed and localized ePDCCH transmission, however, may result in excessive control overhead if both frequency diversity and beamforming gain have to be guaranteed.

In one novel aspect, resource utilization gain is enhanced by multiplexing physical resource for both distributed and localized transmission of ePDCCH in one PRB in order to minimize the control overhead. In the example of FIG. 1, eNodeB 101 allocates a plurality of candidate ePDCCHs within a set of radio resources in subframe 120, which are depicted as a set of PRB pairs by box 130. The radio resources are then mapped to a first set of candidate ePDCCHs according to distributed-ePDCCH mapping rule, which is depicted by box 131. Moreover, the same radio resources are also mapped to a second set of candidate ePDCCHs according to localized-ePDCCH mapping rule, which is depicted by box 132. By multiplexing radio resources for both distributed and localized ePDCCH in the same set of PRB/PRB pairs, resource utilization is improved and control overhead is reduced.

FIG. 2 illustrates simplified block diagrams of a base station 201 and a user equipment 211 in accordance with embodiments of the present invention. For base station 201, antenna 207 transmits and receives radio signals. RF transceiver module 206, coupled with the antenna, receives RF signals from the antenna, converts them to baseband signals and sends them to processor 203. RF transceiver 206 also converts received baseband signals from the processor, converts them to RF signals, and sends out to antenna 207. Processor 203 processes the received baseband signals and invokes different functional modules to perform features in base station 201. Memory 202 stores program instructions and data 209 to control the operations of the base station.

Similar configuration exists in UE 211 where antenna 217 transmits and receives RF signals. RF transceiver module 216, coupled with the antenna, receives RF signals from the antenna, converts them to baseband signals and sends them to processor 213. The RF transceiver 216 also converts received baseband signals from the processor, converts them to RF signals, and sends out to antenna 217. Processor 213 processes the received baseband signals and invokes different functional modules to perform features in UE 211. Memory 212 stores program instructions and data 219 to control the operations of the UE.

The base station 201 and UE 211 also include several functional modules to carry out some embodiments of the present invention. The different functional modules can be implemented by software, firmware, hardware, or any combination thereof. The function modules, when executed by the processors 203 and 213 (e.g., via executing program codes 209 and 219), for example, allow base station 201 to configure downlink control channel and transmit downlink control information to UE 211, and allow UE 211 to receive and decode the downlink control information accordingly. In one example, base station 201 configures a set of radio resources and multiplexes the radio resources for both distributed and localized ePDCCH transmission via control module 208. The downlink control information is then mapped to the configured REs via mapping module 205 using both distributed and localized mapping rules. The downlink control information carried in ePDCCH is then modulated and encoded via encoder 204 to be transmitted by transceiver 206 via antenna 207. UE 211 receives the ePDCCH configuration and the downlink control information by transceiver 216 via antenna 217. UE 211 determines the configured radio resources for both distributed and localized ePDCCH transmission via control module 218 and de-maps the configured REs via de-mapping module 215. UE 211 then demodulates and decodes the downlink information via decoder 214.

The configured set of radio resources for ePDCCH can be in the form of PRBs or PRB pairs. All the REs in the configured PRBs or PRB pairs are mapped to a number of ePDCCH candidates based on a mapping rule. The physical structure of ePDCCH can be one or two levels. First level is a physical unit of enhanced resource element groups (eREGs), where the group of REs is predefined for each eREG. Second level is a logical unit of enhanced control channel elements (eCCEs), where the group of eREGs is predefined or configurable by higher layer for each eCCE. The downlink control information is transmitted on a number of aggregated eCCEs according to the modulation and coding level required. For distributed ePDCCH transmission, the REs employed are always distributed across the configured PRBs so that the frequency diversity can be exploited sufficiently. For localized ePDCCH transmission, the REs employed are within one or a contiguous set of PRBs for better robustness in channel estimation by exploit pre-coding/beamforming gain.

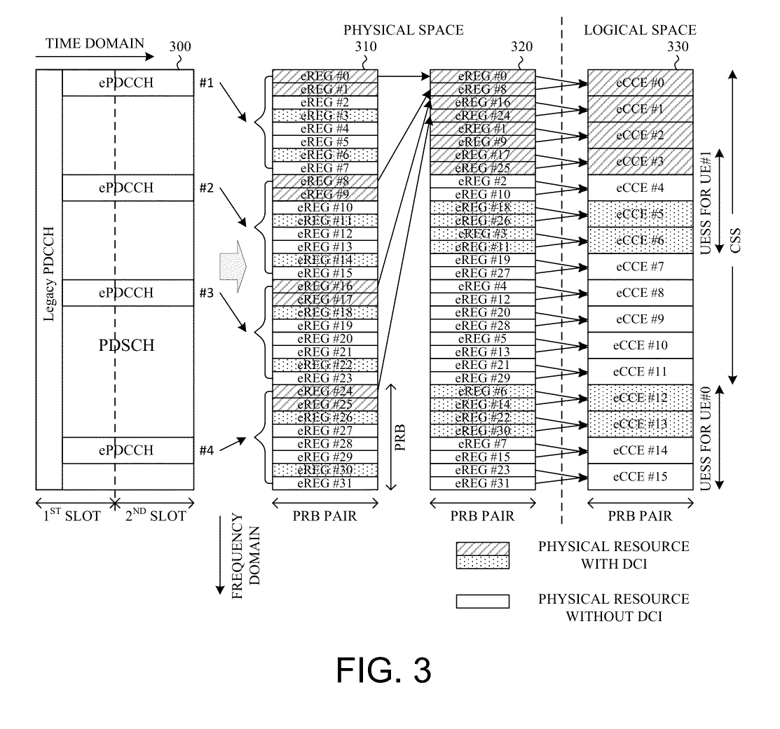

FIG. 3 illustrates one example of radio resource configuration for distributed ePDCCH transmission. As illustrated in FIG. 3, in physical space, a set of distributed-type candidate ePDCCHs are allocated within a set of configured PRBs or PRB pairs (e.g., PRB pairs #1, #2, #3, and #4) in a given subframe 300. The radio resources in PRB pairs #1, #2, #3, and #4 allocated for distributed-type ePDCCHs are first aggregated together. As depicted by box 310, each PRB pair consists of eight physical units of enhanced resource element groups (eREGs). All four PRB pairs together form thirty-two (32) eREGs from eREG #0 to eREG #31. The radio resources in PRB pairs #1, #2, #3, and #4 allocated for distributed-type ePDCCHs are then interleaved to exploit frequency diversity gain for robust DCI reception at the UE side. As depicted by box 320 and box 330, the aggregated and interleaved eREGs are mapped to logical unit of enhanced control channel elements (eCCEs). For example, eREG #0 from PRB #1 and eREG #8 from PRB #2 are mapped to eCCE #0, eREG #16 from PRB #3 and eREG #24 from PRB #4 are mapped to eCCE #1, and so on so forth. Several eCCEs (e.g., 1, 2, 4, or 8 depending on aggregation level) constitutes a candidate ePDCCH. In logical space, the distributed radio resources mapped to eCCEs form either common search space (CSS) and/or UE-specific search space (UESS) for distributed ePDCCH transmission. For example, eCCE #0 to eCCE #11 form a CSS for all UEs, eCCE #3 to eCCE #6 form a UESS for UE #1, and eCCE #12 to eCCE #15 form a UESS for UE #0.

From FIG. 3, it can be seen that because the allocated radio resources are only used for distributed ePDCCH transmission, resource utilization is poor. This is because distributed-type ePDCCH uses scattered radio resources to achieve frequency diversity. In the example of FIG. 3, eCCE #0-eCCE#3 constitute one ePDCCH that carries DCI intended for all UEs, eCCE #5-eCCE#6 constitute another ePDCCH that carries DCI intended for UE #1, and eCCE #12-eCCE #13 constitute another ePDCCH that carries DCI intended for UE #0. Among the allocated 32 eREGs, only 16 eREGs are being used. That is, with 50% loading, another 50% physical resources are wasted because there are no more UEs utilizing distributed-type ePDCCH for schedulers.

To minimize the waste, the same physical resources, such as subcarriers or resource elements (REs) in 3GPP LTE systems, can be assigned as both distributed-type and localized-type ePDCCH. From the eNodeB side, the physical resources assigned as both distributed-type and localized-type ePDCCH can be utilized for the transmission of either distributed-type or localized-type ePDCCH depending on the base station scheduling. The physical resources, which are not used for the transmission of distributed-type ePDCCH, can be used for the transmission of localized-type ePDCCH and vice versa.

From the UE side, UE searches for ePDCCH candidates with the definitions of both distributed-type and localized-type ePDCCH over the physical resources in its search space(s) if the physical resources are assigned as both distributed-type and localized-type ePDCCH. For example, a UE searches for ePDCCH candidates over the physical resources of PRBs with the definitions of both distributed-type ePDCCH for CSS and localized-type ePDCCH for UESS if the CSS and UESS happen to fully or partially overlap with each other and the distributed-type and localized-type ePDCCH is applied for the CSS and UESS of the UE, respectively. With the proposed idea, the physical resource holes due to distributed-type ePDCCH can be filled with localized-type ePDCCH and thus the radio resource utilization efficiency is improved.

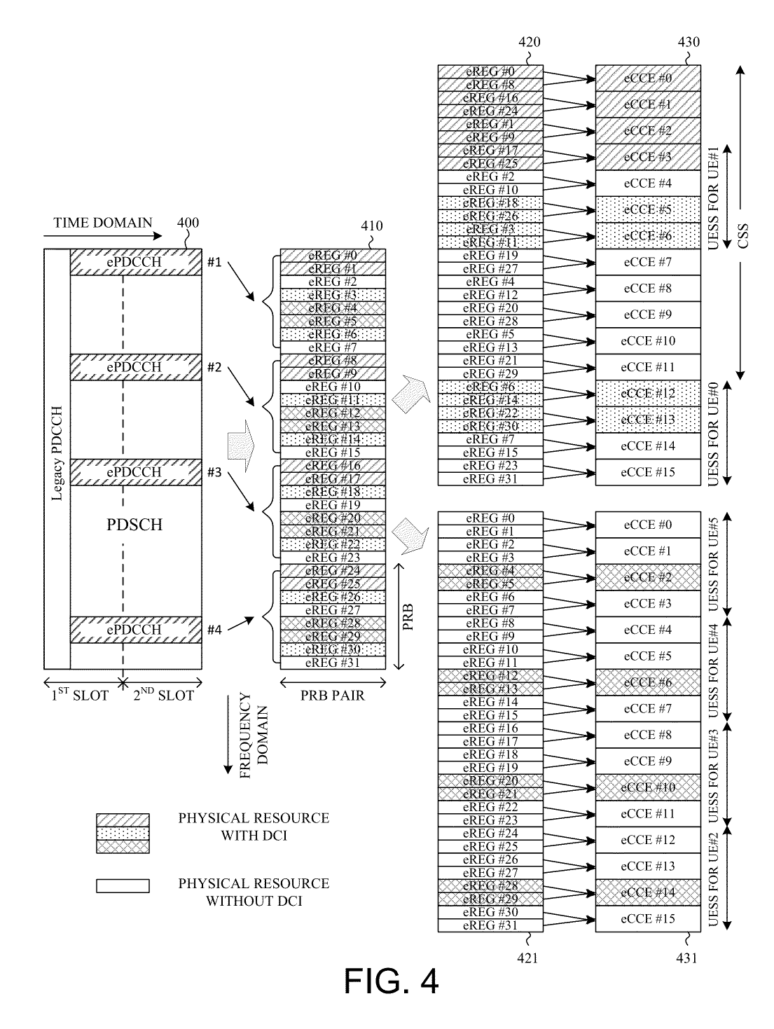

FIG. 4 illustrates a first embodiment of radio resource multiplexing for both distributed and localized ePDCCH transmission. As illustrated in FIG. 4, in physical space, a set of distributed-type and localized-type candidate ePDCCHs are allocated within a set of configured PRBs or PRB pairs (e.g., PRB pairs #1, #2, #3, and #4) in a given subframe 400. The radio resources in PRB pairs #1, #2, #3, and #4 allocated for all candidate ePDCCHs are aggregated together. As depicted by box 410, each PRB pair consists of eight physical units of enhanced resource element groups (eREGs). All four PRB pairs together form thirty-two (32) eREGs from eREG #0 to eREG #31. The radio resources in the four PRB pairs are then mapped to logical unit of enhanced control channel elements (eCCEs). With multiplexing radio resources for distributed ePDCCH and localized ePDCCH, the radio resources in the four PRB pairs are mapped to eCCEs by applying different mapping rules.

For distributed-type ePDCCH, the radio resources in PRB pairs #1, #2, #3, and #4 are interleaved to exploit frequency diversity gain for robust DCI reception at the UE side. As depicted by box 420 and box 430, the aggregated and interleaved eREGs are mapped to logical unit of enhanced control channel elements (eCCEs). For example, eREG #0 from PRB #1 and eREG #8 from PRB #2 are mapped to eCCE #0, eREG #16 from PRB #3 and eREG #24 from PRB #4 are mapped to eCCE #1, and so on so forth. Several eCCEs (e.g., 1, 2, 4, or 8 depending on aggregation level) constitutes a candidate ePDCCH. In logical space, the distributed radio resources mapped to eCCEs form either common search space (CSS) and/or UE-specific search space (UESS) for distributed ePDCCH transmission. For example, eCCE #0 to eCCE #11 form a CSS for all UEs, eCCE #3 to eCCE #6 form a UESS for UE #1, and eCCE #12 to eCCE #15 form a UESS for UE #0.

For localized-type ePDCCH, no interleaving is necessary. As depicted by box 421 and box 431, the aggregated eREGs are mapped to logical unit of enhanced control channel elements (eCCEs). For example, eREG #0 and eREG #1 from PRB #1 are mapped to eCCE #0, eREG #2 and eREG #3 from PRB #1 are mapped to eCCE #1, and so on so forth. Several eCCEs (e.g., 1, 2, 4, or 8 depending on aggregation level) constitutes a candidate ePDCCH. In logical space, the contiguous radio resources mapped to eCCEs typically form UE-specific search space (UESS) for localized ePDCCH transmission. For example, eCCE #0 to eCCE #3 form a UESS for UE #5, eCCE #4 to eCCE #7 form a UESS for UE #4, eCCE #8 to eCCE #11 form a UESS for UE #3, and eCCE #12 to eCCE #15 form a UESS for UE #2.

As illustrated in FIG. 4, the four PRB-pairs are assigned as both distributed-type and localized-type ePDCCH. Similar to FIG. 3, one common search space and two UE-specific search spaces are again defined in the distributed-type ePDCCH for two UEs. For example, eCCE #0 to eCCE #11 form a CSS for all UEs, eCCE #3 to eCCE #6 form a UESS for UE #1, and eCCE #12 to eCCE #15 form a UESS for UE #0. More specifically, eCCEs #0-#3 constitute one ePDCCH that carries DCI intended for all UEs, eCCEs #5-#6 constitute another ePDCCH that carries DCI intended for UE #1, and eCCE #12-#13 constitute another ePDCCH that carries DCI intended for UE #0.

In the example of FIG. 4, four additional localized-type ePDCCHs with the size of one CCE for four UEs can be accommodated in the same PRB-pairs if they are configured to utilize localized-type ePDCCH. For example, eCCE #2 constitutes one ePDCCH for UE #5, eCCE #6 constitutes one ePDCCH for UE #4, eCCE #10 constitutes one ePDCCH for UE #3, and eCCE #14 constitutes one ePDCCH for UE #2. As a result, among the allocated 32 eREGs, 24 eREGs are being used—16 eREGs for distributed-type ePDCCH and 8 eREGs for localized-type ePDCCH. Therefore, as compared to the example illustrated in FIG. 3, four more UEs can be served for scheduling and the wasted physical resources are reduced to 25%.

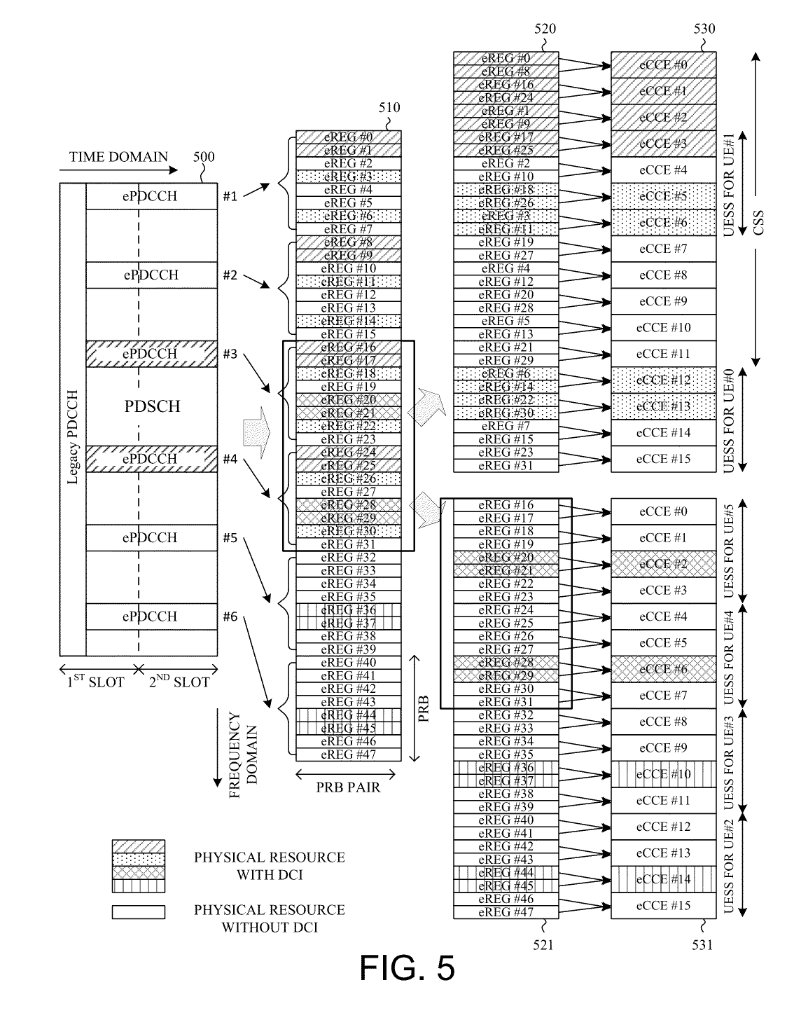

FIG. 5 illustrates a second embodiment of radio resource multiplexing for both distributed and localized ePDCCH transmission. As illustrated in FIG. 5, in physical space, a first set of distributed-type candidate ePDCCHs are allocated within a first set of configured PRBs or PRB pairs (e.g., PRB pairs #1, #2, #3, and #4) in a given subframe 500. In addition, a second set of localized-type candidate ePDCCHs are allocated within a second set of configured PRBs or PRB pairs (e.g., PRB pairs #3, #4, #5, and #6) in the same subframe 500. The radio resources in PRB pairs #1, #2, #3, #4, #5, and #6 allocated for all candidate ePDCCHs are aggregated together. As depicted by box 510, each PRB pair consists of eight physical units of enhanced resource element groups (eREGs). All six PRB pairs together form forty-eight (48) eREGs from eREG #0 to eREG #47. The radio resources in the PRB pairs are then mapped to logical unit of enhanced control channel elements (eCCEs).

For distributed-type ePDCCH, the radio resources in PRB pairs #1, #2, #3, and #4 are interleaved to exploit frequency diversity gain for robust DCI reception at the UE side. As depicted by box 520 and box 530, the aggregated and interleaved eREGs are mapped to logical unit of enhanced control channel elements (eCCEs). For example, eREG #0 from PRB #1 and eREG #8 from PRB #2 are mapped to eCCE #0, eREG #16 from PRB #3 and eREG #24 from PRB #4 are mapped to eCCE #1, and so on so forth. Several eCCEs (e.g., 1, 2, 4, or 8 depending on aggregation level) constitutes a candidate ePDCCH. In logical space, the distributed radio resources mapped to eCCEs form either common search space (CSS) and/or UE-specific search space (UESS) for distributed ePDCCH transmission. For example, eCCE #0 to eCCE #11 form a CSS for all UEs, eCCE #3 to eCCE #6 form a UESS for UE #1, and eCCE #12 to eCCE #15 form a UESS for UE #0. In one specific example of FIG. 5, eCCEs #0-#3 constitute one ePDCCH that carries DCI intended for all UEs, eCCEs #5-#6 constitute another ePDCCH that carries DCI intended for UE #1, and eCCE #12-#13 constitute another ePDCCH that carries DCI intended for UE #0.

For localized-type ePDCCH, no interleaving is necessary. As depicted by box 521 and box 531, the aggregated eREGs are mapped to logical unit of enhanced control channel elements (eCCEs). For example, eREG #16 and eREG #17 from PRB #3 are mapped to eCCE #0, eREG #18 and eREG #19 from PRB #3 are mapped to eCCE #1, and so on so forth. Several eCCEs (e.g., 1, 2, 4, or 8 depending on aggregation level) constitutes a candidate ePDCCH. In logical space, the contiguous radio resources mapped to eCCEs typically form UE-specific search space (UESS) for localized ePDCCH transmission. For example, eCCE #0 to eCCE #3 form a UESS for UE #5, eCCE #4 to eCCE #7 form a UESS for UE #4, eCCE #8 to eCCE #11 form a UESS for UE #3, and eCCE #12 to eCCE #15 form a UESS for UE #2. In one specific example of FIG. 5, eCCE #2 constitutes one ePDCCH for UE #5, eCCE #6 constitutes one ePDCCH for UE #4, eCCE #10 constitutes one ePDCCH for UE #3, and eCCE #14 constitutes one ePDCCH for UE #2.

As illustrated in FIG. 5, PRB-pairs #1, #2, #3, and #4 are assigned as distributed-type ePDCCH, while PRB pairs #3, #4, #5, and #6 are assigned as localized-type ePDCCH. As a result, PRB pairs #3 and #4 are assigned as both distributed-type and localized-type ePDCCH. With multiplexing radio resources for distributed ePDCCH and localized ePDCCH, the radio resources in PRB pairs #3 and #4 are mapped to eCCEs by applying different mapping rules. In the example of FIG. 5, for distributed-type ePDCCH, the radio resource utilization in PRB pairs #1 and #2 is 50%. For localized-type ePDCCH, the radio resource utilization in PRB pairs #5 and #6 is 25%. For both distributed-type and localized-type ePDCCH, the radio resource utilization in PRB pairs #3 and #4 is 75% because of radio resource multiplexing. The physical resource holes due to distributed-type ePDCCH is filled with localized-type ePDCCH.

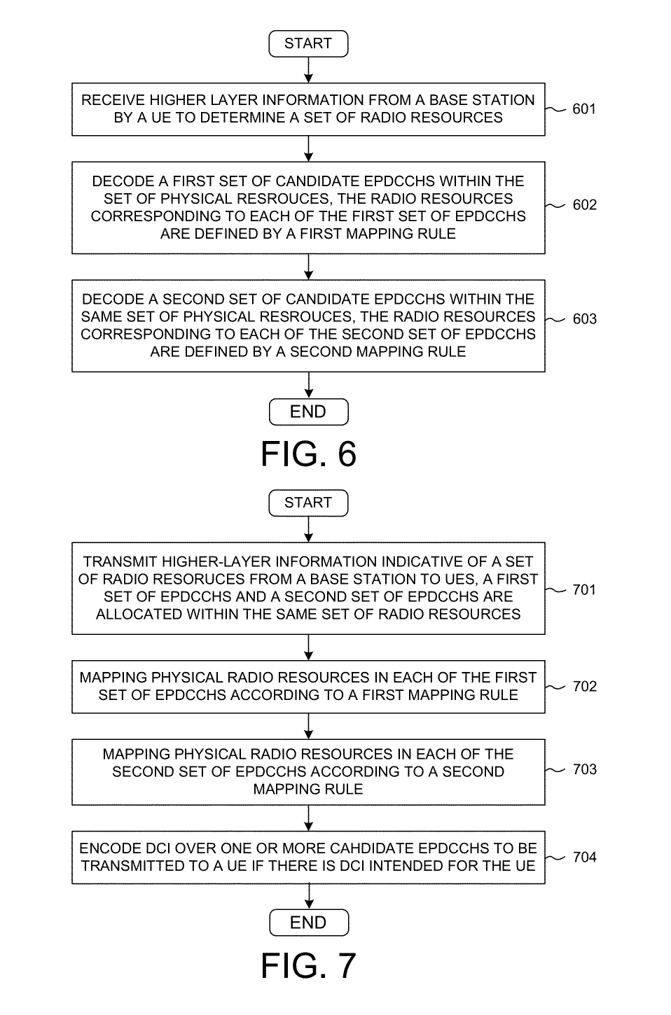

FIG. 6 is a flow chart of a method of radio resource multiplexing for ePDCCH transmission from UE perspective in accordance with one novel aspect. In step 601, a user equipment (UE) receives higher layer information transmitted from a base station in a wireless network. In one example, the higher layer information may be carried by radio resource control (RRC) signaling, and the UE determines a set of radio resources, such as physical resource block (PRB) or PRB pairs based on the RRC signaling. In step 602, the UE decodes a first set of candidate enhanced physical downlink control channel (ePDCCHs) within the set of received radio resources. The radio resources correspond to each of the first set of ePDCCHs are defined by a first mapping rule. In step 603, the UE decodes a second set of candidate ePDCCHs within the same set of received radio resources. The radio resources correspond to each of the second set of candidate ePDCCHs are defined by a second mapping rule. In one example, the first mapping rule is for distributed-type ePDCCH, where the radio resources employed by each distributed-type ePDCCH are distributed in the entire operation bandwidth (scattered over non-contiguous set of PRBs). The second mapping rule is for localized-type ePDCCH, where the radio resources employed by each localized-type ePDCCH are within one or a contiguous set of PRBs.

FIG. 7 is a flow chart of a method of radio resource multiplexing for ePDCCH transmission from eNodeB perspective in accordance with one novel aspect. In step 701, a base station transmits higher layer information (e.g., via RRC signaling) indicative of a set of radio resources (e.g., PRB or PRB pairs) to a plurality of user equipment (UEs). The base station allocates a first set of candidate enhanced physical downlink control channels (ePDCCHs) and a second set of ePDCCHs are allocated within the same set of radio resources. In step 702, the base station maps physical radio resource in each of the first set of ePDCCHs according to a first mapping rule. In step 703, the base station maps physical radio resources in each of the second set of ePDCCHs according to a second mapping rule. In step 704, the base station encodes downlink control information (DCI) over one or more candidate ePDCCHs to be transmitted to a UE if there is DCI intended for the UE. In one example, the first mapping rule is for distributed-type ePDCCH, where the radio resources employed by a distributed-type ePDCCH are distributed in the entire operation bandwidth (scattered over non-contiguous set of PRBs). The second mapping rule is for localized-type ePDCCH, where the radio resources employed by a localized-type ePDCCH are within one or a contiguous set of PRBs. By multiplexing radio resources for distributed and localized ePDCCH transmission within the same set of PRBs, radio resource utilization is enhanced.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
receiving higher-layer information from a base station by a user equipment (UE) to determine a set of radio resources;
decoding a first set of candidate enhanced physical downlink control channels (ePDCCHs) within the set of received radio resources, wherein radio resources corresponding to each of the first set of ePDCCHs are defined by a first mapping rule; and
decoding a second set of candidate ePDCCHs within the same set of received radio resources, wherein radio resources corresponding to each of the second set of candidate ePDCCHs are defined by a second mapping rule.

2. The method of claim 1, wherein the set of radio resources is a set of physical resource blocks (PRBs).

3. The method of claim 2, wherein the first set of candidate ePDCCHs is of distributed type, wherein radio resources employed by each distributed ePDCCH spread across multiple non-contiguous PRBs.

4. The method of claim 2, wherein the second set of candidate ePDCCHs is of localized type, wherein radio resources employed by each localized ePDCCH are within one PRB or contiguous PRBs.

5. The method of claim 1, wherein the higher-layer information is carried by radio resource control (RRC) signaling.

6. The method of claim 1, wherein each candidate ePDCCH corresponds to a monitored downlink control information (DCI) format.

7. The method of claim 1, wherein each candidate ePDCCH is associated with a set of enhanced control channel elements (eCCEs), and wherein each eCCE consists of a number of enhanced resource element groups (eREGs) based on the first or the second mapping rule.

8. A user equipment (UE), comprising:
a receiver that receives higher-layer information from a base station to determine a set of radio resources;
a first decoder that decodes a first set of candidate enhanced physical downlink control channels (ePDCCHs) within the set of radio resources, wherein the radio resources corresponding to each of the first set of ePDCCHs are defined by a first mapping rule; and
a second decoder that decodes a second set of candidate ePDCCHs within the same set of radio resources, and wherein the radio resources corresponding to each of the second set of candidate ePDCCHs are defined by a second mapping rule.

9. The UE of claim 8, wherein the set of radio resources is a set of physical resource blocks (PRBs).

10. The UE of claim 9, wherein the first set of candidate ePDCCHs is of distributed type, wherein radio resources employed by each distributed ePDCCH spread across multiple non-contiguous PRBs.

11. The UE of claim 9, wherein the second set of candidate ePDCCHs is of localized type, wherein radio resources employed by each localized ePDCCH are within one PRB or contiguous PRBs.

12. The UE of claim 8, wherein the higher-layer information is carried by radio resource control (RRC) signaling.

13. The UE of claim 8, wherein each candidate ePDCCH corresponds to a monitored downlink control information (DCI) format.

14. The UE of claim 8, wherein each candidate ePDCCH is associated with a set of enhanced control channel elements (eCCEs), and wherein each eCCE consists of a number of enhanced resource element groups (eREGs) based on the mapping rule.

15. A method comprising:
transmitting higher-layer information indicative of a set of radio resources from a base station to a plurality of user equipment (UEs), wherein a first set of candidate enhanced physical downlink control channels (ePDCCHs) and a second set of ePDCCHs are allocated within the same set of radio resources;
mapping physical radio resources in each of the first set of candidate ePDCCHs according to a first mapping rule;
mapping physical radio resources in each of the second set of candidate ePDCCHs corresponds to a second mapping rule; and
encoding downlink control information (DCI) over one or more candidate ePDCCHs to be transmitted to a UE if there is DCI intended for the UE.

16. The method of claim 15, wherein the set of radio resources is a set of physical resource blocks (PRBs).

17. The method of claim 16, wherein the first set of candidate ePDCCHs is of distributed type, wherein radio resources employed by distributed ePDCCHs spread across multiple non-contiguous PRBs.

18. The method of claim 16, wherein the second set of candidate ePDCCHs is of localized type, wherein radio resources employed by localized ePDCCHs are within one PRB or contiguous PRBs.

19. The method of claim 15, wherein the higher-layer information is carried by radio resource control (RRC) signaling.

20. The method of claim 15, wherein each candidate ePDCCH is associated with a set of enhanced control channel elements (eCCEs), and wherein each eCCE consists of a number of enhanced resource element groups (eREGs) based on the mapping rule.
